(19) United States
(12) Patent Application Publication
(10) Pub. No.: US 2023/0022625 A1
(43) Pub. Date: Jan. 26, 2023

(54) CONTENT MANAGEMENT IN APPLICATION

(71) Applicant: Lemon Inc., Grand Cayman (KY)

(72) Inventors: Liqun NI, Los Angeles, CA (US); Lingyuan KE, Los Angeles, CA (US); Pankesh JHAVERI, Los Angeles, CA (US); Haoyu JIANG, Los Angeles, CA (US); Yan YAN, Los Angeles, CA (US); Fan GAO, Los Angeles, CA (US); Cheng WANG, Los Angeles, CA (US); Junfu CHEN, Los Angeles, CA (US)

(21) Appl. No.: 17/957,470

(22) Filed: Sep. 30, 2022

(51) Int. Cl. G06Q 30/02

(52) U.S. Cl. CPC G06Q 30/0244; G06Q 30/0277; G06Q 30/0249

(57) ABSTRACT

A method is proposed for providing a content page in an application. In the method, a media item is generated, and the media item is associated with respective resources in a resource list that is received from a resource provider. The media item is presented in the application. A content page is caused to be displayed in response to detecting an interaction event of a user of the application with the media item, the content page including respective content items for the respective resources. Therefore, the media item and the content page are generated and displayed in an automatic way for the one or more resource providers without any label work from the resource providers.

### FIELD

The present disclosure generally relates to content management, and more specifically, to methods, devices, and computer program products for providing a content page in an application.

### BACKGROUND

With the development of the network technology, various types of contents (such as videos, images, audios, web pages, etc.) may be accessed via the network. Here, the content may be related to various resources, including physical products (such as electronic devices, furniture, clothes, shoes, and the like), and virtual products (such as applications that may be installed in electronic devices, audio and video content that may be played in electronic devices, and the like). Resource providers (such as online shopping websites for the physical products or producers of the virtual products) may publish promotion contents (such as video advertisements) for their resources. For example, these contents may be displayed in various applications for promotional purposes. However, usually the resource providers have relatively low abilities in making attractive and effective videos, and this leads to an unsatisfactory result of resource promotion.

### SUMMARY

In a first aspect of the present disclosure, there is provided a method for sample classification. In the method, a media item is generated, and the media item is associated with respective resources in a resource list that is received from a resource provider. The media item is presented in the application. A content page is caused to be displayed in response to detecting an interaction event of a user of the application with the media item, the content page including respective content items for the respective resources.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features, and advantages of the present disclosure will become more apparent, wherein the same reference generally refers to the same components in the implementations of the present disclosure.

FIG. 1 illustrates an example environment for content management in which implementations of the present disclosure may be applied;

FIG. 2 illustrates a block diagram for providing a content page via an application according to a solution;

FIG. 3 illustrates a block diagram for providing a content page via an application according to implementations of the present disclosure;

FIG. 4 illustrates a block diagram for generating a media item that is to be provided in an application according to implementations of the present disclosure;

FIG. 5 illustrates a block diagram for generating a media item based on attributes of resources according to implementations of the present disclosure;

FIG. 6 illustrates a block diagram for launching a content item page associated with a content item in a content page according to implementations of the present disclosure;

FIG. 7 illustrates a block diagram for adjusting a media item in an application based on an interaction event according to implementations of the present disclosure;

FIG. 8 illustrates an example flowchart of a method for providing a content page via an application according to implementations of the present disclosure; and

FIG. 9 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

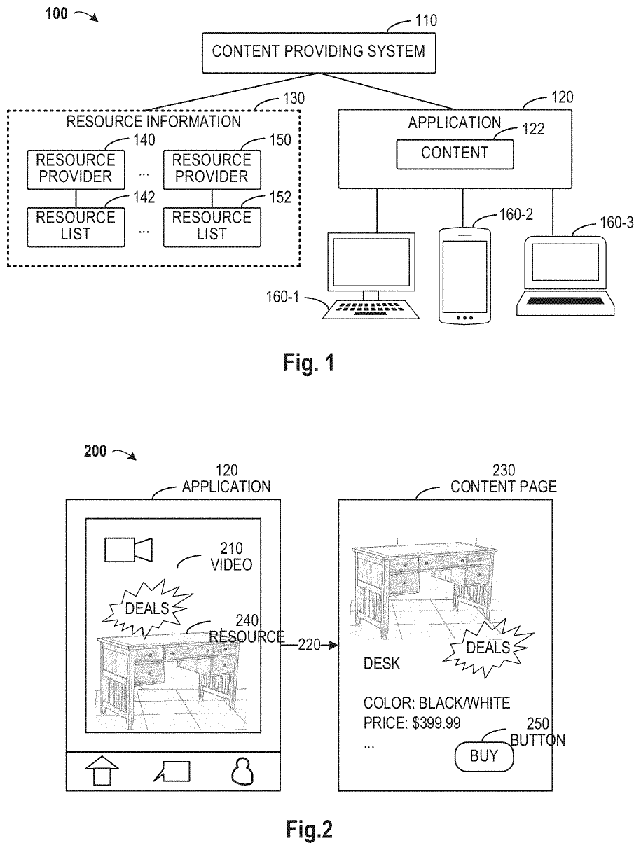

FIG. 1 illustrates a schematic diagram of an example environment 100 in which embodiments of the present disclosure may be applied. In FIG. 1, one or more resource providers 140, . . . , and 150 may call a content providing system 110 to manage contents that are to be displayed in an application 120. Here, the resource provider 140 may have a resource list 142, . . . , and the resource provider 150 may have a resource list 152. Each resource provider may generate a corresponding content 122 related to its resource list and request the content providing system 110 to display the content 122 in the application 120. Once the content 122 is displayed, users of the application 120 may access the content 122 via one or more terminal devices 160-1, 160-2, 160-3 (collectively or individually referred to as the terminal device 160 for discussion), and the like. The resource providers 140, . . . , and 150 may generate the content 122 in a variety of formats, for example, including but not be limited to the video, text, image, audio, and webpage formats.

In the context of the present disclosure, more details may be provided by taking a video application as an example of the application 120, and the content 122 may be a video as an example. Alternatively and/or in addition to, the application 120 may have another function such as a communication system, a social network system, and the like; and the content 122 may include the video, text, image, audio, and webpage formats. For the purpose of description, the resource providers 140 and 150 may be online shops for selling physical products such as furniture, electronic devices, and the like. Alternatively and/or in addition to, the resource providers may sell other physical or virtual products.

FIG. 2 illustrates a block diagram 200 for providing a content page in an application 120 according to a solution. As shown in FIG. 2, the resource provider 140 may generate a video 210 for promoting a resource 240 (such as a desk) in the resource list 142 and the video 210 may be presented in the application 120 by the content providing system 110. A user of the application 120 may see the video 210, and if he/she is interested in the video 210, the user may click the video 210 to launch 220 a content page 230 that is associated with the resource 240 promoted in the video 210. Here, the content page 230 may include detailed information about the desk, and the user may browse the content page 230 and then place an order by clicking a button 250.

In the example of FIG. 2, the resource provider 140 needs to generate the video 210 by itself, however usually the resource provider 140 has limited skills in making video, and it is difficult to generate attractive videos. At this time, it is desirable to reduce the workload of the resource provider and help the resource provider without any video generation skill to publish promotional content about their own resources in the application 120.

In view of the above, the present disclosure proposes a content management solution. Specifically, the resource list 142 may be received from the resource provider 140. Further, a media item may be generated for respective resources in the resource list and presented in the application 120. For example, the media item may be obtained by the content providing system 110 without any label work from the resource provider 140. Here, the media item may be associated with respective resources in the resource list 142 that is received from the resource provider 140, and then information about respective resources may be shown to the user of the application 120 by presenting the media item. Further, interactions between the user and the media item may be detected. If an interaction event is detected, a content page including respective content items for the respective resources may be displayed for leading the user to the corresponding shopping webpage.

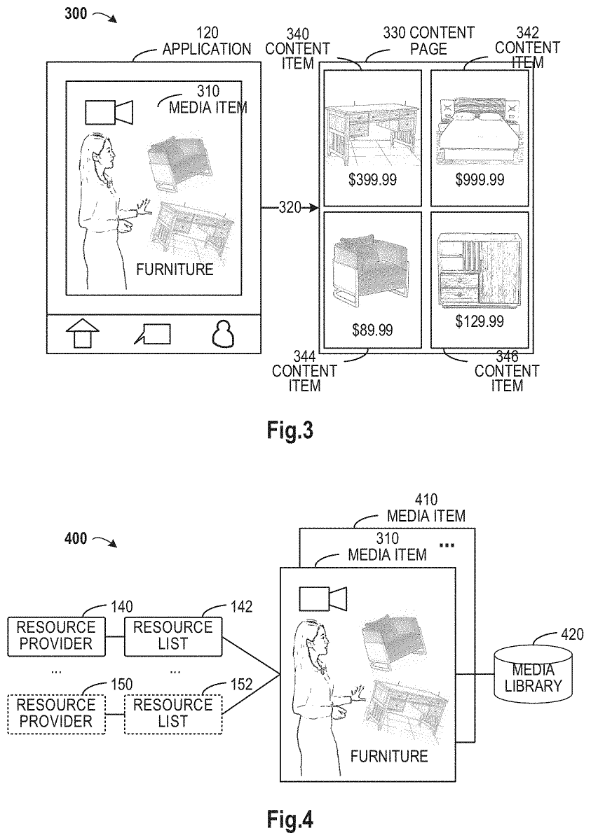

Referring to FIG. 3 for a visual presentation of the above proposed solution, where FIG. 3 illustrates a block diagram 300 for providing a content page via an application according to implementations of the present disclosure. In FIG. 3, a media item 310 (such as a video) may be generated and presented in the application 120. Here, the media item 310 may include information about respective resources in the resource list(s) from the resource provider(s). In other word, the media item 310 may reflect multiple resources from one or more resource providers in a comprehensive way, and the media item 310 may be a promotion video corresponding to multiple resources. For example, if the resource provider sells the furniture, then the media item 310 may be a video for introducing furniture promotions, and/or other information that may attract the user to buy the furniture.

If the user is interested in the media item 310, then he/she may interact 320 with the media item 310 and go to the online shopping webpage. For example, the user may interact with the media item 310 via any the following actions: a click action, a swipe action, a slide action, and the like, so as to launch a content page 330. Here, the content page 330 may include multiple content items associated with multiple resources from the one or more resource lists. In an example where there are only two resource providers 140 and 150, the resource list 142 from the resource provider 140 may include a desk and a bed (for example, corresponding to the content items 340 and 342), and the resource list 152 from the resource provider 150 may include a sofa and a cabinet (for example, corresponding to the content items 344 and 346). At this point, the user may see multiple resources provided by the multiple resource providers in the single content page 330.

Although the above paragraphs show a scenario where one resource list is received from one resource provider, there may be multiple resource lists and thus the media item 310 may be generated for promoting multiple resources from multiple resource lists. With implementations of the present disclosure, each resource provider does not need to generate its own advertisement video by itself. Instead, the media item 310 may be generated by the content providing system 110, and thus the resource provider may get rid of the heavy workload for generating the advertisement video. Further, the resource providers that do not have any video making skill may directly submit the resource lists to the content providing system 110 and then have their resources displayed and viewed by the users of the application 120.

Meanwhile, the media item 310 for advertising the multiple resources occupies only one video slot in the application 120. Here, the video slot represents an area in the interface of the application 120 within which a video may be displayed, and the interface may hold one or more video slots. Compared with conventional solutions where an individual video is provided for promoting an individual resource, limited video slots in the application 120 may act as multiple portals to multiple content pages, respectively, and each content page may include more content items for more resources. Therefore, the application 120 may provide more information and then serve more resource providers in a parallel way.

Having provided the brief of the present disclosure, reference will be made to FIG. 4 for more details about the content providing procedure. FIG. 4 illustrates a block diagram 400 for generating a media item that is to be provided in an application according to implementations of the present disclosure. As shown in FIG. 4, the media items 310, . . . , and 410 may be generated based on respective resources in the resource list 142. When there are multiple resource providers 140, . . . , and 150, the media items 310, . . . , and 410 may be generated for respective resources in the plurality of resource lists 142, . . . , and 152. Then, the generated media items 310, . . . , 410 may be stored in a media library 420. In order to generate the media item 310, . . . , and 410, each resource list may be analyzed for extracting the respective resources. Further, attributes may be extracted from the respective resources and then used for generating the media item 310.

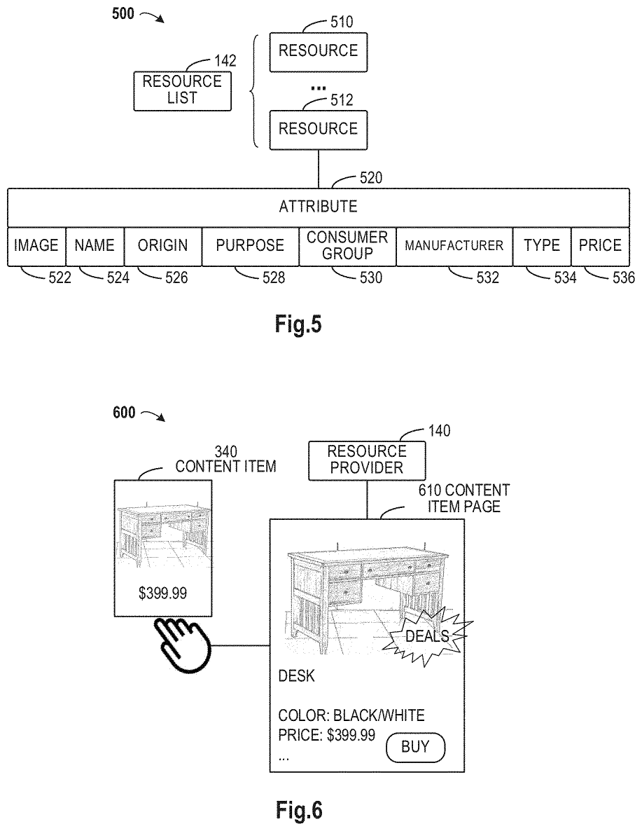

FIG. 5 illustrates a block diagram 500 for generating a media item based on attributes of resources according to implementations of the present disclosure. In FIG. 5, the resource list 142 may include multiple resource 510, . . . , and 512, and then attributes may be extracted from each resource. For example, the attribute 520 for one resource may include any of: an image 522, a name 524, an origin 526, a purpose 528, a consumer group 530, a manufacturer 532, a type 534, a price 536, and the like. In implementations of the present disclosure, the machine learning technique may be used for generating the media item 310. For example, a video generating model may be trained from a group of training samples and then the trained video generating model may generate the media item in an automatic way according to various attributes of the resources.

In implementations of the present disclosure, one or more media items may be generated in advance and stored in the media library 420, such that an appropriate media item may be selected from the media library 420 for being presented in the application 120. With these implementations, multiple media items may be generated in a fast and automatic way, and then one media item with a better performance may be selected for redirecting the users from the application 120 to the content page 330.

In implementations of the present disclosure, the media items may be generated in a manual way. For example, the resource list(s) may be provided to video generation experts, video generation studios, video generation teams, and the like. Here, the manually generated media item may better represent characteristics of various aspects of the resources in a more creative way, attract the users to watch and interact with the media item, and then redirect the users to the content page. Here, creative teams work for the content providing system 110 and third-party creators/creative agencies for video generation may be invited for generating the video. Therefore, these attractive videos may be displayed in combination with products in an aggregated landing page. Here, the videos may be generic to be associated with any products, or may be theme-based (e.g., shopping categories, shopping seasons, promotions) to be associated with more granular product categories. Further, the videos may be continuously generated/refreshed in accordance with demand, supply, and creative fatigue.

Once the media item 310 is generated, it may be presented to the user in the application 120. For example, the media item 310 may be presented in the landing page of the application 120 when the user just opens the application 120. Alternatively and/or in addition to, the media item 310 may be presented periodically when the user goes through videos provided in the application 120. Further, the media item 310 may be presented when the user shows some interest in a certain video. For example, if the user viewed a video related to furniture for several times, then the media item 310, which leads the user to the content page 330 selling furniture, may be provided to the user.

In implementations of the present disclosure, since the content page 330 includes multiple content items, it is desired that the user is interested in most of the displayed content items, so as to increase the recommendation effects. At this point, relevant resources may be selected from the resource list(s) before generating the respective content items in the content page 330. For example, a classification may be determined based on types of respective resources in the plurality of resource lists, and then the media item 310 may be generated based on the classification.

Supposing the resource provider 140 sells both of furniture and electronic devices, then the resources may be classified into two classifications, and then the media item 310 may be generated for the furniture, and another media item may be generated for the electronic devices. In implementations of the present disclosure, different media items may be presented to different users. Specifically, the interaction histories of the user may be used for determining which content page should be displayed to the user. At this point, the user (to whom the media item 310 is displayed) may be selected from a plurality of users of the application 120 based on interaction histories of the plurality of users.

Specifically, if the historical logs show that the user likes videos related to house decoration and furniture, then the media item 310 may be provided to the user. If the historical logs show that the user likes videos related to the electronic devices, then the other media item including electronic devices advertisements may be provided to the user. Once the media item 310 is displayed to the user, the user may possibly place an order, which leads to a conversion of the advertisement. Here, the conversion occurs when the user completes a desired event associated with the displayed content item. The event that leads to the conversion may vary and be determined in a number of ways. For example, the conversion may occur when the displayed content item is clicked, the conversion may also be defined by any measurable/observable event specified by the resource provider, such as a download event, a registering event, a subscribe event, an order event, a pay event, and the like. It is to be understood that the above events are just examples, and other events may be used for defining the conversion.

With these implementations, a corresponding media item may be displayed to the user, and there is a higher probability that the user is interested in the media item 310 and will click the media item 310. Therefore, the user may possibly place an order and then a conversion rate related to the content page 330 may be increased.

In implementations of the present disclosure, the media item 310 may be provided in the application 120 based on whether the media item 310 will lead to any benefit. Here, a computation resource overhead indicates a supply cost for providing the media item 310 in the application 120. The supply cost is an opportunity the content providing system 110 would otherwise earn if another media item instead of the media item 310 is presented in the application 120. Here, the supply cost may be determined based on an auction between multiple resource providers who want to present their advertisements in the application 120.

Specifically, the supply cost may be determined according to the generalized second-price (GSP) auction. The generalized second-price auction is a non-truthful auction mechanism for multiple items. Each bidder places a bid, the highest bidder gets the first slot, the second-highest bidder gets the second slot, and so on. However, the highest bidder pays the price bid by the second-highest (2nd-sorted) bidder, the second-highest pays the price bid by the third-highest (3rd-sorted) bidder, and so on. Specifically, the supply cost may be determined based on the follow formula 1.

$$supplyCost = 3 rdSortedEcpm - 2 ndHiddenCost \approx 2 ndSortedEcpm * auctionDiscount - 2 ndHiddenCost \approx 2 ndSortedEcpm * auctionDiscount - 2 ndSortedEcpm * hiddenCostRatioInSortedEcpm = 2 ndSortedEcpm * ( auctionDiscount - hiddenCostRatioInSortedEcpm ) = 2 ndSortedEcpm * Coef \qquad Formula 1$$

In Formula 1, supplyCost represents the supply cost for presenting the media item 310, 3ndSortedEcmp and 2ndHiddenCost indicate the eCPM (Effective Cost Per Thousand, which indicates the cost per kilo of online advertising pricing) costs related to the third and second slots, respectively. 2ndHiddenCost indicates the hidden cost related to the second slot, auctionDiscount indicates the discount in the auction, hiddenCostRatiolnSortedEcpm indicates the hidden cost ratio for the sorted eCPM, and Coef indicates a predetermined coefficient (for example, determined based on the historical statistics.

Further, the benefit for providing the media item 310 in the application 120 may be determined. Here, the benefit may be the revenue that the content providing system 110 may gain from the landing page (or another position for presenting the media item 310) in the application 120. Then, the media item 310 may be presented in the application 120 based on a comparison of a computation overhead and the benefit, in a direction that makes a ratio between the computation overhead and the benefit to approach 1:1. With these implementations, the limited computation resource resources may be used for promoting more contents while ensuring the benefit of the content providing system 110.

In implementations of the present disclosure, the content page 330 may also be generated based on the various attributes of the respective resources in the plurality of resource lists. For example, the content page 330 may have a grid layout as shown in FIG. 3, where each grid corresponding to a resource in the resource list. With these implementations, a single video slot in the application 120 may redirect the user to the content page 330 that includes more than one content items. Further, each content item may show a brief of the resource's information, such as the image, the price, an introduction, and the like. Here, the multiple content items may be ranked, and the content page 330 may be scrolled in response to a swipe up action or a swipe down action by the user. With these implementations, the media item 330 displayed in a single video slot may redirect the user to more resources, and then the limited displaying area in the application 120 may lead the user to access more information about the resources.

In implementations of the present disclosure, the resource providers' budgets for promoting their resources may be used for ranking the content items in the content page 330. Here, the budget refers to the computation overhead for promoting the resource to the user. Specifically, the budget may be represented by the computation resource cost in the content providing system 110, such as the storage resource, the network resource, and the like. Here, the computation resource cost may be normalized by the number of normalized computation units that are to be allocated for representing the resources, and the resource provider may be charged when applying for the computation units. For example, if the resource provider 140 applies 10 computation units for displaying the content items 340 and 342, and the resource provider 150 applies 5 computation units for displaying the content items 344 and 346, then the content items 340 and 342 may be listed before the content items 344 and 346.

Specifically, respective computation budgets may be obtained from respective resource providers, and then the respective content items may be ranked in the content page 330 according to the respective computation budgets. With these implementations, computation units in the content providing system 110 may be fully utilized and the limited computation units be allocated based on the number of the computation units that have been applied for displaying the content items. Therefore, the content providing system 110 may be controlled in a more flexible and effective way.

In implementations of the present disclosure, the user may go through the content page 330, and if an interaction event is detected between the user and a content item in the content page 330, a corresponding content item page may be launched for retrieving a resource associated with the content item. FIG. 6 illustrates a block diagram 600 for launching a content item page associated with a content item 340 in a content page 330 according to implementations of the present disclosure. As shown in FIG. 6, the user may click the content item 340 so as to launch the content item page 610 that is provided by the resource provider 140. In the content item page 610, more information may be provided about the resource, which allows the user to know more details about the desk. Further, the content item page 610 may provide an online customer service, for example, the user may ask questions about the desk.

The present disclosure does not limit the way for launching the content item page 610. For example, the content item page 610 may be opened in the application 120, alternatively and/or in addition to, the content item page 610 may be opened in another application such as a general web browser installed in the terminal device 160. With these implementations, the user may be redirected to the shopping website maintained by the resource provider 140. As the resource provider 140 is more familiar with its own resources, the content item may be exhibited in a more effective way.

In implementations of the present disclosure, the media item 330 that is provided in the application 120 may be adjusted based on the interaction event between the user and the content page 330. Specifically, multiple types of interaction events may be detected according to a promotion goal of the resource provider. For example, the promotion goal may specify: the resource provider desires 100 users to place the order after being redirected to the content page 330. At this point, the order event by the user may be detected. In another example, the promotion goal may specify: the resource provider is expecting a total amount of sales of “$10000.” At this point, the order event and the unit price related to the order event should be detected.

In implementations of the present disclosure, it may be determined whether a promotion goal of the resource provider (that is associated with the content item) is met based on the interaction event, and then the media item 310 may be adjusted based on whether the promotion goal is met. Continuing the above example, with respect to the content item 340 in FIG. 6, the order event may be detected for each user that is presented with the content page 330. If it is detected that 100 users have already placed their orders, the promotion goal is met and then the media item 310 may not be displayed any more. In other words, the content providing system 110 may cease displaying the media item 310 such that no user will be redirected to the content page 330. In another example, the multiple content items may be related to different promotion goals and thus the content item (with the achieved promotion goal) may be removed from the content page 330.

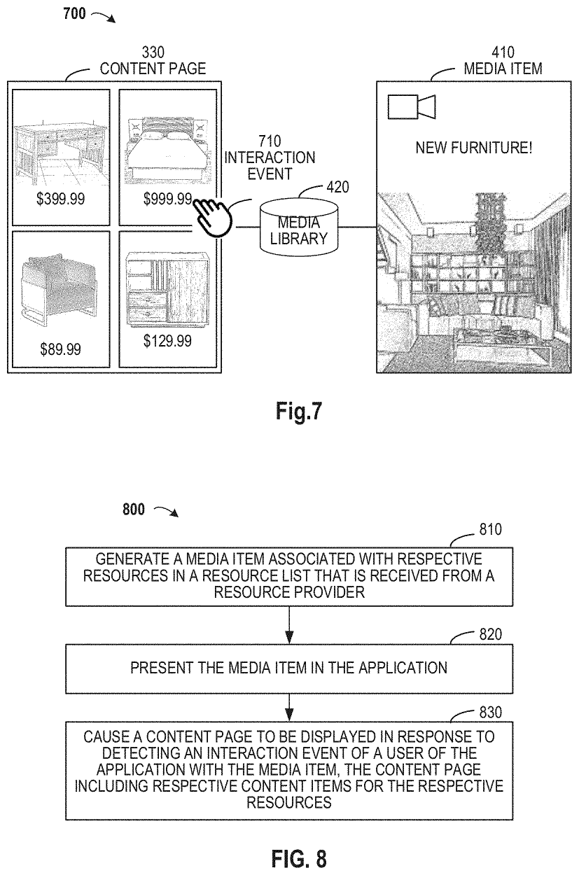

In implementations of the present disclosure, if the promotion goal is not met yet, a potential reason for this scenario may possibly be that the media item 310 is not attractive for leading enough users to the content page 330. At this point, another media item (for example, the media item 410 in the media library 420) may be selected for replacing the media item 310. FIG. 7 illustrates a block diagram 700 for adjusting a media item in an application based on an interaction event according to implementations of the present disclosure.

As shown in FIG. 7, an interaction event 710 may be collected when the user is browsing the content page 330. If the promotion goal is not achieved according to the interaction event 710, then the media item 410 may be selected from the media library 420 and then be displayed in the application 120. Further, performance of the media item 410 may be monitored based on further interaction event of the user. If the promotion goal is met, then the media item 410 may not be played any more. With these implementations, one or more media items in the media library 420 may be displayed in the application 120 for achieving the promotion goal.

In implementations of the present disclosure, the above solution may be implemented in the content providing system 110. Accordingly, the media item 310 and the content page 330 are generated in an automatic way for the one or more resource providers without any label work from the resource providers. Further, the limited video slots in the application 120 may be fully utilized for redirecting the user to more content items. Although the above paragraphs describe the content management solution by taking the video as an example of the media item, the media item may include other formats such as the text format, the image format, the audio format, the webpage format and the like.

With the media library 420 with tens of or even more generated videos, the content providing system 110 may automate video selection and shuffle to maximize advertisement performance. For example, with respect to the resource list(s) provided by the resource provider(s), the content providing system 110 may select a video from the media library, with a purpose of maximizing the likelihood that the user clicks and converts. Further, the content providing system 110 may shuffle videos to mitigate the creative fatigue problem, which may happen when a video is displayed for 1 to 2 weeks. Meanwhile, the content providing system 110 may monitor the conversion performance related to the video and then instruct new videos to achieve the promotion goal.

The above paragraphs have described details for providing a content page in an application. According to implementations of the present disclosure, a method is proposed for providing a content page in an application. Reference will be made to FIG. 8 for more details about the method, here FIG. 8 illustrates an example flowchart of a method for providing a content page via an application. At a block 810, a media item is generated, and the media item is associated with respective resources in a resource list that is received from a resource provider. At a block 820, the media item is presented in the application. At a block 830, a content page is caused to be displayed in response to detecting an interaction event of a user of the application with the media item, the content page including respective content items for the respective resources.

In implementations of the present disclosure, causing the content page to be displayed comprises: generating the respective content items included in the content page based on attributes of the respective resources in the resource list; and providing the content page by ranking the respective content items.

In implementations of the present disclosure, providing the content page by ranking the respective content items comprises: obtaining respective computation resource budgets that the resource provider applied for displaying the respective resources in the resource list; and ranking the respective content items in the content page according to the respective computation budgets.

In implementations of the present disclosure, the method further comprises: in response to detecting an interaction event of the user with a content item in the respective content items in the content page, launching a content item page for retrieving a resource associated with the content item, the content item page being provided by the resource provider.

In implementations of the present disclosure, the method further comprises: in response to detecting an interaction event by the user with the content item, adjusting the media item that is provided in the application based on the interaction event.

In implementations of the present disclosure, adjusting the media item comprises: determining whether a promotion goal of the resource provider is met based on the interaction event; and adjusting the media item that is provided in the application based on whether the promotion goal is met.

In implementations of the present disclosure, adjusting the media item that is provided in the application based on whether the promotion goal is met comprises at least one of: ceasing presenting the media item in the application in response to determining that the promotion goal is met; presenting a further media item associated with the respective resources in the resource list in response to determining that the promotion goal is not met.

In implementations of the present disclosure, presenting the media item in the application comprises: determining a computation resource overhead for providing the media item in the application; determining benefit for providing the content item in the application; and providing the media item in the application based on a comparison of a computation overhead and the benefit.

In implementations of the present disclosure, generating the media item comprises: determining a classification for the respective resources based on types of the respective resources in the resource list; and generating the media item based on the classification.

In implementations of the present disclosure, presenting the media item further comprises: selecting, from a plurality of users of the application, the user associated with the classification based on interaction histories of the plurality of users; and presenting the media item to the user in the application.

According to implementations of the present disclosure, an apparatus is provided for providing a content page in an application. The apparatus comprises: a generating module, being configured for generating a media item associated with respective resources in a resource list that is received from a resource provider; a presenting module, being configured for presenting the media item in the application; and a causing module, being configured for causing a content page to be displayed in response to detecting an interaction event of a user of the application with the media item, the content page including respective content items for the respective resources. Further, the apparatus may comprise other modules for implementing other steps in the above method.

According to implementations of the present disclosure, an electronic device is provided for implementing the above method. The electronic device comprises: a computer processor coupled to a computer-readable memory unit, the memory unit comprising instructions that when executed by the computer processor implements a method for providing a content page in an application. The method comprises: generating a media item associated with respective resources in a resource list that is received from a resource provider; presenting the media item in the application; and causing a content page to be displayed in response to detecting an interaction event of a user of the application with the media item, the content page including respective content items for the respective resources.

In implementations of the present disclosure, causing the content page to be displayed comprises: generating the respective content items included in the content page based on attributes of the respective resources in the resource list; and providing the content page by ranking the respective content items.

In implementations of the present disclosure, providing the content page by ranking the respective content items comprises: obtaining respective computation resource budgets that the resource provider applied for displaying the respective resources in the resource list; and ranking the respective content items in the content page according to the respective computation budgets.

In implementations of the present disclosure, the method further comprises: in response to detecting an interaction event of the user with a content item in the respective content items in the content page, launching a content item page for retrieving a resource associated with the content item, the content item page being provided by the resource provider.

In implementations of the present disclosure, the method further comprises: in response to detecting an interaction event by the user with the content item, adjusting the media item that is provided in the application based on the interaction event.

In implementations of the present disclosure, adjusting the media item comprises: determining whether a promotion goal of the resource provider is met based on the interaction event; and adjusting the media item that is provided in the application based on whether the promotion goal is met.

In implementations of the present disclosure, adjusting the media item that is provided in the application based on whether the promotion goal is met comprises at least one of: ceasing presenting the media item in the application in response to determining that the promotion goal is met; presenting a further media item associated with the respective resources in the resource list in response to determining that the promotion goal is not met.

In implementations of the present disclosure, presenting the media item in the application comprises: determining a computation resource overhead for providing the media item in the application; determining benefit for providing the content item in the application; and providing the media item in the application based on a comparison of a computation overhead and the benefit.

In implementations of the present disclosure, generating the media item comprises: determining a classification for the respective resources based on types of the respective resources in the resource list; and generating the media item based on the classification.

In implementations of the present disclosure, presenting the media item further comprises: selecting, from a plurality of users of the application, the user associated with the classification based on interaction histories of the plurality of users; and presenting the media item to the user in the application.

According to implementations of the present disclosure, a computer program product, the computer program product comprising a computer readable storage medium having program instructions embodied therewith, the program instructions executable by an electronic device to cause the electronic device to perform the method 800.

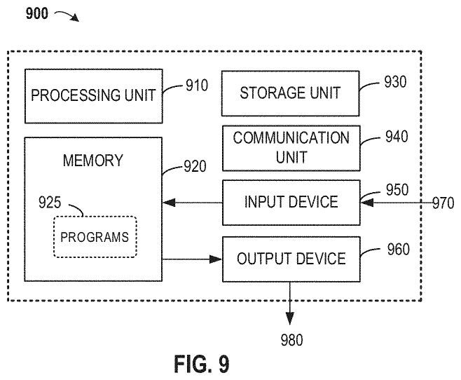

FIG. 9 illustrates a block diagram of a computing device 900 in which various implementations of the present disclosure can be implemented. It would be appreciated that the computing device 900 shown in FIG. 9 is merely for purpose of illustration, without suggesting any limitation to the functions and scopes of the present disclosure in any manner. The computing device 900 may be used to implement the above method 900 in implementations of the present disclosure. As shown in FIG. 9, the computing device 900 may be a general-purpose computing device. The computing device 900 may at least comprise one or more processors or processing units 910, a memory 920, a storage unit 930, one or more communication units 940, one or more input devices 950, and one or more output devices 960.

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller, or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk, or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem, and the like) enabling the computing device 900 to communicate with one or more other computing devices, if required. Such communication can be performed via input/output (I/O) interfaces (not shown).

In some implementations, instead of being integrated in a single device, some, or all components of the computing device 900 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for providing a content page in an application, comprising:
generating a media item associated with respective resources in a resource list that is received from a resource provider;
presenting the media item in the application; and
causing a content page to be displayed in response to detecting an interaction event of a user of the application with the media item, the content page including respective content items for the respective resources.

2. The method of claim 1, wherein causing the content page to be displayed comprises:
generating the respective content items included in the content page based on attributes of the respective resources in the resource list; and
providing the content page by ranking the respective content items.

3. The method of claim 2, wherein providing the content page by ranking the respective content items comprises:
obtaining respective computation resource budgets that the resource provider applied for displaying the respective resources in the resource list; and
ranking the respective content items in the content page according to the respective computation budgets.

4. The method of claim 1, further comprising: in response to detecting an interaction event of the user with a content item in the respective content items in the content page, launching a content item page for retrieving a resource associated with the content item, the content item page being provided by the resource provider.

5. The method of claim 1, further comprising: in response to detecting an interaction event by the user with the content item, adjusting the media item that is provided in the application based on the interaction event.

6. The method of claim 5, wherein adjusting the media item comprises:
determining whether a promotion goal of the resource provider is met based on the interaction event; and
adjusting the media item that is provided in the application based on whether the promotion goal is met.

7. The method of claim 6, wherein adjusting the media item that is provided in the application based on whether the promotion goal is met comprises at least one of:
ceasing presenting the media item in the application in response to determining that the promotion goal is met; and
presenting a further media item associated with the respective resources in the resource list in response to determining that the promotion goal is not met.

8. The method of claim 1, wherein presenting the media item in the application comprises:
determining a computation resource overhead for providing the media item in the application;
determining benefit for providing the content item in the application; and
providing the media item in the application based on a comparison of a computation overhead and the benefit.

9. The method of claim 1, wherein generating the media item comprises:
determining a classification for the respective resources based on types of the respective resources in the resource list; and
generating the media item based on the classification.

10. The method of claim 9, wherein presenting the media item further comprises:
selecting, from a plurality of users of the application, the user associated with the classification based on interaction histories of the plurality of users; and
presenting the media item to the user in the application.

11. An electronic device, comprising a computer processor coupled to a computer-readable memory unit, the memory unit comprising instructions that when executed by the computer processor implements a method for providing a content page in an application, the method comprises:
generating a media item associated with respective resources in a resource list that is received from a resource provider;
presenting the media item in the application; and
causing a content page to be displayed in response to detecting an interaction event of a user of the application with the media item, the content page including respective content items for the respective resources.

12. The device of claim 11, wherein causing the content page to be displayed comprises:
generating the respective content items included in the content page based on attributes of the respective resources in the resource list; and
providing the content page by ranking the respective content items.

13. The device of claim 12, wherein providing the content page by ranking the respective content items comprises:
obtaining respective computation resource budgets that the resource provider applied for displaying the respective resources in the resource list; and
ranking the respective content items in the content page according to the respective computation budgets.

14. The device of claim 11, wherein the method further comprises: in response to detecting an interaction event of the user with a content item in the respective content items in the content page, launching a content item page for retrieving a resource associated with the content item, the content item page being provided by the resource provider.

15. The device of claim 11, wherein the method further comprises: in response to detecting an interaction event by the user with the content item, adjusting the media item that is provided in the application based on the interaction event.

16. The device of claim 15, wherein adjusting the media item comprises:
determining whether a promotion goal of the resource provider is met based on the interaction event; and
adjusting the media item that is provided in the application based on whether the promotion goal is met.

17. The device of claim 16, wherein adjusting the media item that is provided in the application based on whether the promotion goal is met comprises at least one of:
ceasing presenting the media item in the application in response to determining that the promotion goal is met; and
presenting a further media item associated with the respective resources in the resource list in response to determining that the promotion goal is not met.

18. The device of claim 11, wherein presenting the media item in the application comprises:
determining a computation resource overhead for providing the media item in the application;
determining benefit for providing the content item in the application; and
providing the media item in the application based on a comparison of a computation overhead and the benefit.

19. The device of claim 11, wherein generating the media item comprises:
determining a classification for the respective resources based on types of the respective resources in the resource list; and
generating the media item based on the classification; and
wherein presenting the media item further comprises:
selecting, from a plurality of users of the application, the user associated with the classification based on interaction histories of the plurality of users; and
presenting the media item to the user in the application.

20. A computer program product, the computer program product comprising a computer readable storage medium having program instructions embodied therewith, the program instructions executable by an electronic device to cause the electronic device to perform a method for providing a content page in an application, the method comprises:
generating a media item associated with respective resources in a resource list that is received from a resource provider;
presenting the media item in the application; and
causing a content page to be displayed in response to detecting an interaction event of a user of the application with the media item, the content page including respective content items for the respective resources.
